(19) United States
(12) Patent Application Publication
(10) Pub. No.: US 2006/0184342 A1
(43) Pub. Date: Aug. 17, 2006

(54) Network configuration management by model finding

(76) Inventor: Sanjai Narain, Madison, NJ (US)

Correspondence Address: TELCORDIA TECHNOLOGIES, INC., ONE TELCORDIA DRIVE 5G116, PISCATAWAY, NJ, 08854-4157, US

(21) Appl. No.: 11/284,368

(22) Filed: Nov. 21, 2005

Related U.S. Application Data
(60) Provisional application No. 60/630,056, filed on Nov. 22, 2004.

(51) Int. Cl. G06F 17/10

(52) U.S. Cl. 703/2

(57) ABSTRACT

Complex, end-to-end network services are set up via the configuration method: each component has a finite number of configuration parameters each of which is set to definite values. End-to-end network service requirements can be on connectivity, security, performance and fault-tolerance. A number of subsidiary requirements are created that constrain, for example, the protocols to be used, and the logical structures and associated policies to be set up at different protocol layers. By performing different types of reasoning with these requirements, different configuration tasks are accomplished. These include configuration synthesis, configuration error diagnosis, configuration error fixing, reconfiguration as requirements or components are added and deleted, and requirement verification. A method of performing network configuration management by model finding formalizes and automates such reasoning using a logical system called Alloy. Given a first-order logic formula and a domain of interpretation, Alloy tries to find whether the formula is satisfiable in that domain, i.e., whether it has a model. Alloy is used to build a Requirement Solver that takes as input a set of network components and requirements upon their configurations and determines component configurations satisfying those requirements. This Requirement Solver is used in different ways to accomplish the above reasoning tasks.

### CROSS-REFERENCE TO RELATED APPLICATIONS

This application claims the benefit of the filing date of U.S. Provisional Patent Application No. 60/630,056, filed Nov. 22, 2004, the disclosure of which is hereby incorporated herein by reference.

### FIELD OF THE INVENTION

The present invention relates to network management configuration and specifically, relates to a method of formalizing network requirements and automating associated reasoning when configuring a network.

### BACKGROUND OF THE INVENTION

Automating solutions to fundamental network configuration management problems such as specifying system requirements, configuration synthesis, requirement strengthening, component addition, configuration error diagnosis, configuration error troubleshooting, and requirement verification is a long time issue.

Policy based networking (PBN) is an approach to solve the problems. However, a large amount of the reasoning must be explicitly programmed with PBNs in the form of if-condition-then action-rules. The present invention performs such reasoning automatically. In addition, policy-based networking is concerned only with configuration synthesis and not with other problems such as diagnosis, verification, and the like. Policy based networking is described in the publication by B. Moore et al entitled “Policy Core Information Model —Version 1 Specification, IETF RFC 3060, February 2001, available at http://www.ietf.org/rfc/frc3060.txt IETF's policy-based networking group does not propose any explicit representation of system requirements. Instead, the logic is procedurally encoded in the form of if-condition-then-action rules. The problem with this approach is that these rules have to be changed or extended every time new requirements or components are added or deleted. In effect, these rules have to do all of the work of a Requirement Solver (Alloy model finder), which is a primary feature of the present invention.

In the paper “Making collaborative system administration easier: constraints and declarative aspect precedence”, by A. Holt and J Hawkins, Proc. Of SAICSIT-2004, the expressive power of configuration constraints is highly limited. The authors say that they do not want to admit arbitrary Boolean combinations of constraint expressions. In accordance with the present invention, negative membership specifications and arbitrary Boolean combinations of constraints are handled. In addition, the Holt et al paper is only concerned with configuration synthesis and not the other problems mentioned above.

In the paper “SmartFrog meets LCFG: Autonomous Reconfiguration with Central Policy Control”, Paul Anderson, Patrick Goldsack, and Jim Paterson describe another declarative system called LCFG for configuration management, but again, LCFG is only concerned with configuration synthesis and not the other problems.

In a paper by S. Narain, T. Cheng, B. Coan, V. Kaul, K. Parmeswaran, W. Stephens. entitled “Building Autonomic Systems Via Configuration” in Proceedings of AMS Autonomic Computing Workshop, Seattle, Wash., 2003, formalized requirements of Prolog are described. Prolog is based on definite clauses, hence it is not possible to specify full first-order logic constraints such as “every GRE tunnel is protected by an IPSec tunnel”, and “no two distinct interfaces on a router are on the same subnet”. These constraints are possible in the present invention and are useful for network configuration.

In accordance with the teachings of the present invention, the Requirement Solver remains unchanged. It is only the requirements or the scope that change. The Requirement Solver automatically adjusts to these changes and finds new network configurations. Verification is another application of the Requirement Solver.

### SUMMARY OF THE INVENTION

The present invention proposes an approach for formalizing network requirements and automating associated reasoning. The approach is based on a new logical system called Alloy (alloy.mit.edu). While Alloy is based in set theory, a subset of it also has an intuitive object-oriented interpretation: allowing one to specify object types, their attributes and type of attribute values. It also allows one to specify first-order logic constraints on the objects. Finally, Alloy allows one to specify a “scope” that defines a finite number of object instances of each type in a given system. Given a specification and a scope, Alloy attempts to find values of attributes of object instances in the scope that satisfy the specification. These values together constitute a “model” of the specification in the system in the logical sense of the word “model”. Alloy first compiles a specification into a propositional formula in conjunctive normal form, then uses a satisfiability solver such as Berkmin (http://eigold.tripod.com/BerkMin.html) or Zchaff (http://www.princeton.edu/˜chaff) to check whether the formula is satisfiable. If so, it converts satisfying values of propositional variables back into values of attributes and displays these. Often, more than one solution is found.

The Alloy system allows for the definition of first-order constraints on objects and their attributes in a system and also a “scope”, i.e., the number and type of objects in the system. Alloy then uses a satisfiability (SAT) solver to compute a “model” of the constraints in the scope. The present invention uses the Alloy system to solve the configuration management problems. This is a nonobvious and unintended application of the Alloy system which was invented to solve verification problems in software design. Moreover, the present invention includes methods of writing efficient and compact Alloy specifications. These include scope splitting, minimizing quantifiers and avoiding unintended answers.

Automating solutions to fundamental network configuration management problems such as specifying system requirements, configuration synthesis, requirement strengthening, component addition, configuration error diagnosis, configuration error troubleshooting, and requirement verification is accomplished by the use of a Requirement Solver. The Requirement Solver receives as inputs a set of requirements upon a set of objects of different types, and computes as an output, network configurations of those objects such that the requirements are true. The Requirement Solver is used in different ways to solve the abovementioned problems.

The invention introduces the notion of a Requirement Solver and shows how fundamental configuration management tasks can be naturally formalized and carried out using it. The Requirement Solver is implemented in the logical system called Alloy. Alloy is based on the concept of model finding in finite domains, rather than theorem proving. The Requirement Solver is illustrated in the context of a realistic fault-tolerant VPN with remote access. However, the network configuration management method is equally applicable to any protocol, including but not limited to, VoIP and mobile hosted networks. Approaches for writing “efficient” specification are described below.

Complex, end-to-end network services are set up via a configuration method: each component has a finite number of configuration parameters each of which is set to a definite value. End-to-end network service requirements can be based on connectivity, security, performance and fault-tolerance. However, there is a large conceptual gap between end-to-end requirements and detailed component configurations. In order to bridge this gap, a number of subsidiary requirements are created that constrain, for example, the protocols to be used, and the logical structures and associated policies to be set up at different protocol layers. By performing different types of reasoning with these requirements, different configuration tasks are accomplished. These include configuration synthesis, configuration error diagnosis, configuration error fixing, reconfiguration as requirements or components are added and deleted, and requirement verification. However, such reasoning is currently ad hoc. Network requirements are not precisely specified hence automation of reasoning is virtually impossible. This is a major reason for the high cost of network management and total cost of ownership.

The present invention provides solutions to the fundamental network configuration management problems by formalizing network requirements and automating associated reasoning when configuring a network using a Requirement Solver.

The present invention of network configuration management is applicable to any protocol, including but not limited to, VoIP and mobile hosted networks.

The invention will be better understood when the following description is read in conjunction with the accompanying drawings.

### BRIEF DESCRIPTION OF THE DRAWINGS

FIG. 1 is a schematic representation of the functional operation of a Requirement Solver.

FIG. 2 is a schematic representation of a fault-tolerant virtual private network with remote access.

FIG. 3 is a schematic representation of a configuration synthesis of a physical network.

FIG. 4a is a schematic representation of requirement strengthening by adding an overlay.

FIG. 4b is a schematic representation of requirement strengthening by securing the overlay.

FIG. 4c is a schematic representation of requirement strengthening by adding a remote access server.

FIG. 5a is a schematic representation of component addition of adding a new spoke router.

FIG. 5b is a schematic representation of component addition of adding an additional hub router.

FIG. 6 is a schematic representation of advertisement of internal subnet Y into WAN by legacy router.

### DETAILED DESCRIPTION

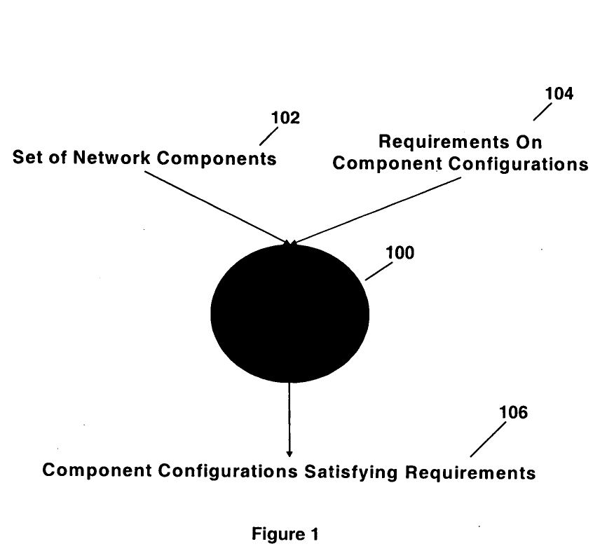

Alloy is used to realize the concept of a Requirement Solver as shown in FIG. 1. The Requirement Solver 100 has two input items: a set of network components 102 and requirements of component configurations 104, and produces as its output, component configurations satisfying the requirements 106.

The Requirement Solver has a direct implementation in Alloy. Network component types, attributes and values are directly modeled in Alloy. A set of network components of different types is modeled as a scope. Network system configuration is modeled as values of all component attributes in a given scope. Network requirements are modeled using first-order logic. Solutions are found by the Alloy interpreter.

The Requirement Solver can be used to accomplish a variety of reasoning tasks:
1. Configuration Synthesis: to determine how to configure a set of components so that they satisfy a system requirement R, submit the set of components and system requirement to the Requirement Solver and produce the output.
2. Requirement Strengthening: if a set of components satisfies a system requirement R but must now satisfy another requirement S, then to reconfigure components, submit the set of components and R [symbol] S to the Requirement Solver and produce the output.
3. Component Addition: if a new component is to be added to a set of components already satisfying requirement R, then to configure the new component and possibly reconfigure existing components, submit the new set of components (including the new component) and R to the Requirement Solver and produce the output.
4. Requirement Verification: to prove that it is impossible for an undesirable requirement U to be true when a set of components satisfies requirement R, submit the set of components and R [symbol] U to the Requirement Solver. If the Requirement Solver cannot find a solution, the assertion is proved.
5. Configuration Error Detection: to check whether configuration of a given set of components is consistent with a requirement R, represent the configuration as a set C of constraints each of the form P=V where P is a configuration parameter and V its value. Then, submit the set of components and R [symbol] C to the Requirement Solver. If the Requirement Solver cannot produce a solution, a configuration error is detected.
6. Configuration Error Fixing: if the configuration of a given set of components is inconsistent with a requirement R, then submit the set of components and R to the Requirement Solver and find a new solution that is as “close” as possible to the current configuration.

The Requirement Solver is illustrated in depth, by carrying out tasks 1-4 above in the context of a realistic fault-tolerant virtual private network with remote access. Approaches for making the present approach scale to networks of realistic size and complexity are outlined below.

Fault-Tolerant Virtual Private Network with Remote Access

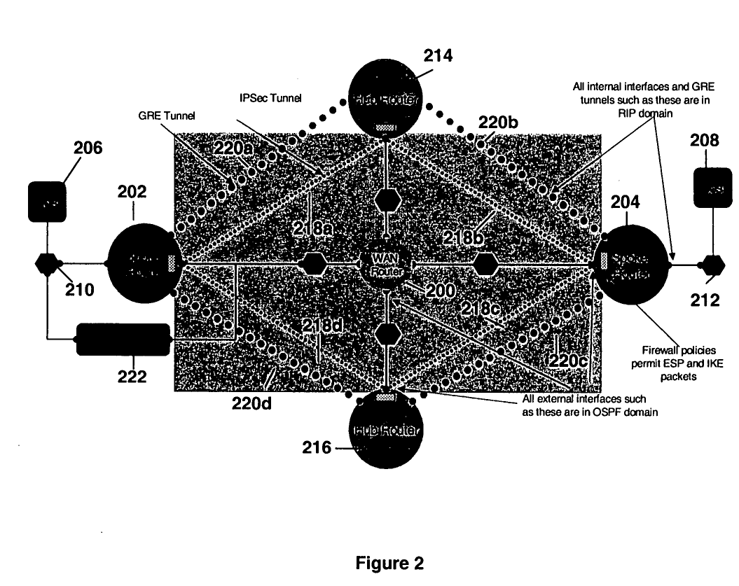

As shown in FIG. 2, a primary goal of the present invention is to synthesize a fault-tolerant network that enables hosts, including mobile hosts, at geographically distributed sites to securely collaborate. A network design for achieving this goal will now be described. The existence of a wide-area network (WAN), represented by a WAN router 200 in FIG. 2, is assumed. Each site has a gateway router 202, 204, called a spoke router, whose external (or public) interface is connected to the WAN and whose internal (or private) interface is connected to hosts 206, 208 and servers 210, 212 in the site. A routing protocol is run on the external interfaces of the spoke router and WAN routers to automatically compute routes between these interfaces. As traffic between hosts and servers on different sites is intended to be private, it cannot be allowed to flow directly over the wide area network. In order to secure the network, one possibility is to set up a full-mesh of IPSec tunnels between gateway routers. However, full-mesh is not scalable since the number of tunnels increases as the square of the number of sites. For example, for a 200 site domain, the number of tunnels would be nearly 20,000. A scalable alternative is a hub-and-spoke architecture as shown. A certain number of hub routers 214, 216 is provided. Each spoke router 202, 204 sets up an IPSec tunnel 218a-d to each hub router 214, 216. Traffic from one site to another goes via two tunnel hops, one from its spoke router to a hub router and another from the hub router to the destination site's spoke router. The number of tunnels now only increases linearly with the number of sites.

The problem, however, is that if a hub router fails, connectivity between sites is lost. This is because the source spoke router will continue to send traffic through the IPSec tunnel to the failed hub router. IPSec has no notion of fault-tolerance that will enable the source spoke router to redirect traffic via another hub router. Routing protocols such as RIP (Routing Information Protocol) or OSPF (Open Shortest Path First) accomplish precisely this kind of fault-tolerance; however, they are incompatible with IPSec. They do not recognize an IPSec tunnel as directly connecting two routers since there can be multiple physical hops in between. The solution is to set up a new type of tunnel, called GRE, between each hub and spoke router. The purpose of the GRE tunnel 220a-d is to create the illusion to a routing protocol that two routers are directly connected, even when there are multiple physical hops in between. This is done by creating new GRE interfaces at each tunnel end point and making these end points belong to the same point-to-point subnet. If a hub router fails, a routing protocol will automatically direct traffic through another GRE tunnel to another hub router, and then to the destination. Each GRE tunnel is then secured via an IPSec tunnel. Thus, the required fault-tolerant virtual private network is set up. If two hub router failures are to be tolerated, the number of tunnels is just 600 or 3% of nearly 20,000 in the full mesh case.

The described solution has a useful defense-in-depth feature: there are two separate routing domains, the external domain and the overlay domain. No routes are exchanged between these domains. Thus, even if an adversary compromises the WAN router, a packet cannot be sent to a host. The WAN router does not have a route to the host.

In order to enable remote users to securely collaborate, a remote access server 222 is set up in “parallel” with a spoke router 202. A remote user connected to the WAN sets up an L2TP tunnel between its host and the server. This tunnel gives the illusion to the host of being directly connected to the internal interface of the site spoke router. Consequently, all traffic between the host and any other host or server on the VPN is also secured. It is necessary to ensure that two separate routing protocols run on the access server, one protocol for the private side and another protocol for the public.

In order to realize the above design, the following types of configuration parameters need to be set:
1. Addressing: Router interface address, type and subnet mask.
2. IPSec: Tunnel end points, hash and encryption algorithms, tunnel modes, pre-shared keys and traffic filters.
3. OSPF: Whether it is enabled at an interface, and OSPF area and type identifiers.
4. GRE: Tunnel end points and physical end points supporting GRE tunnels.
5. Firewall: Policies at each site.
6. Remote access: Subnets to which remote access server interfaces belong and routing protocols enabled on these.

It is very hard to compute values of the above configuration parameters. The types of configuration errors that can arise are:
1. Duplicate IP addresses may be set up, or all interfaces on a subnet may not have the same type.
2. IPSec tunnels may be set up incorrectly. For example, the pre-shared key, hash algorithm, encryption algorithm, or authentication mode may be unequal at the two tunnel end points. Peer values may not be mirror images of each other. These errors can lead to loss of connectivity. If the wrong traffic filter is used, then sensitive data can be transmitted without being encrypted.
3. OSPF routing domain may be set up incorrectly, for example, it may not be enabled at a required interface or the area and type identifiers may be incorrect. This can lead to incorrect routing tables and to outright isolation of subnets.
4. Routing loops may arise. If the same OSPF process is also used for routing between the gateway and WAN routers, then if it does not find a path through the physical network it will attempt to find a path through the overlay network. Since the overlay network is supported by the physical network, a routing loop will arise. This problem can be mitigated by using two distinct routing protocols, one for the overlay and another for the WAN.
5. GRE tunnels may be set up incorrectly. For example, the peer values may not be mirror images of each other, or the mapping between GRE ports and physical ports may be incorrect.
6. Firewall policies may block IPSec traffic, hence no traffic will pass through the tunnels.
7. Remote access interfaces may not belong to the correct subnets and incorrect routing protocols may be configured on these.

Before describing how to formalize the above design in Alloy, its main intuitions are captured in the following requirements:

RouterInterfaceRequirements

1. Each spoke router has internal and external interfaces.
2. Each access server has internal and external interfaces.
3. Each hub router has only external interfaces.
4. Each WAN router has only external interfaces.
   SubnettingRequirements
5. A router does not have more than one interface on a subnet.
6. All internal interfaces are on internal subnets.
7. All external interfaces are on external subnets.
8. Every hub and spoke router is connected to a WAN router.
9. No two non-WAN routers share a subnet.
   RoutingRequirements
10. RIP is enabled on all internal interfaces.
11. OSPF is enabled on all external interfaces.
   GRERequirements
12. There is a GRE tunnel between each hub and spoke router.
13. RIP is enabled on all GRE interfaces.
   SecureGRERequirements
14. For every GRE tunnel there is an IPSec tunnel between associated physical interfaces that secures all GRE traffic.
   Access ServerRequirements
15. There exists an access server and spoke router such that the server is attached in “parallel” to the router.
   AccessControlPolicyRequirements
16. Each hub and spoke external interface permits esp and ike packets.
   Requirement Formalization in Alloy

The following shows an Alloy formalization of network component types, subtypes and their attributes. It also shows a formalization of Requirements 12 and 14 above. The complete formalization is provided in the Appendix. Comment lines begin with “—”.

```
----------Router signatures
sig router { }
sig wanRouter extends router { }
sig hubRouter extends router { }
sig spokeRouter extends router { }
sig accessServer extends router { }
----------Interface signatures
sig interface {
    routing:routingDomain}
sig physicalInterface extends interface {
    chassis: router,
    network: subnet}
sig internalInterface extends physicalInterface { }
sig externalInterface extends physicalInterface { }
sig hubExternalInterface extends externalInterface { }
sig spokeExternalInterface extends externalInterface { }
---------Routing protocol signatures
sig routingDomain { }
sig ripDomain extends routingDomain { }
sig ospfDomain extends routingDomain { }
----------Subnet signatures
sig subnet{ }
sig internalSubnet extends subnet{ }
sig externalSubnet extends subnet{ }
----------Protocol signatures
sig protocol { }
sig ike extends protocol { }
sig esp extends protocol { }
sig gre extends protocol { }
-----------Permission signatures
sig permission { }
sig permit extends permission { }
sig deny extends permission { }
----------Firewall policy signature
sig FirewallPolicy {
    prot: protocol,
    action: permission,
    protectedInterface: physicalInterface}
-----------IPSec Tunnel signature
sig ipsecTunnel {
    local: externalInterface,
    remote: externalInterface,
    protocolToSecure: protocol}
----------GRE Tunnel signature
sig greTunnel {
    localPhysical: externalInterface,
    routing: routingDomain,
    remotePhysical: externalInterface}
-----------IP Packet signature
sig ipPacket {
    source:interface,
    destination:interface,
    prot:protocol}
```

The Alloy version of RouterInterfaceRequirements is:

pred RouterInterfaceRequirements ( )
{
(all x:spokeRouter | some y:internalInterface | y.chassis = x) &&
(all x:spokeRouter | some y:spokeExternalInterface | y.chassis = x) &&
(all x:accessServer | some y:internalInterface | y.chassis = x) &&
(all x:accessServer | some y:externalInterface | y.chassis = x) &&
(all x:hubRouter | some y:hubExternalInterface | y.chassis = x)&&
(all x:wanRouter | some y:externalInterface | y.chassis = x)

The Alloy version of RoutingRequirements is:

```
pred RoutingRequirements ( ) {
    ripOnInternalInterfaces ( )
    ospfOnExternalInterfaces ( )}
pred ripOnInternalInterfaces ( ) {
    all x:internalInterface | x.routing = ripDomain}
pred ospfOnExternalInterfaces ( ) {
    all x:externalInterface | x.routing = ospfDomain}
```

The Alloy version of Requirement 12 is:

```
{all x:hubExternalInterface, y:spokeExternalInterface | some g:greTunnel |
  (g.localPhysical=x && g.remotePhysical=y) or
  (g.localPhysical=y && g.remotePhysical=x)}
```

The following states that between every hubExternalInterface x and spokeExternalInterface y there is a greTunnel whose local physical is x and remotePhysical is y or vice versa.

The Alloy version of Requirement 14 is:

```
{all g:greTunnel |
    some p:ipsecTunnel | p.protocolToSecure=gre &&
    ((p.local = g.localPhysical && p.remote = g.remotePhysical) or
    (p.local = g.localPhysical && p.remote = g.remotePhysical))}
```

Configuration Synthesis

The following shows how to synthesize the initial network with connectivity and routing.

Define PhysicalSpec=

RouterInterfaceRequirements

[symbol]

SubnettingRequirements

[symbol]

RoutingRequirements

Define a scope consisting of:

1 hubRouter
1 spokeRouter
1 wanRouter
1 internalInterface
4 externalInterface
1 hubExternalInterface
1 spokeExternalInterface
1 ripDomain
1 ospfdomain
3 subnet

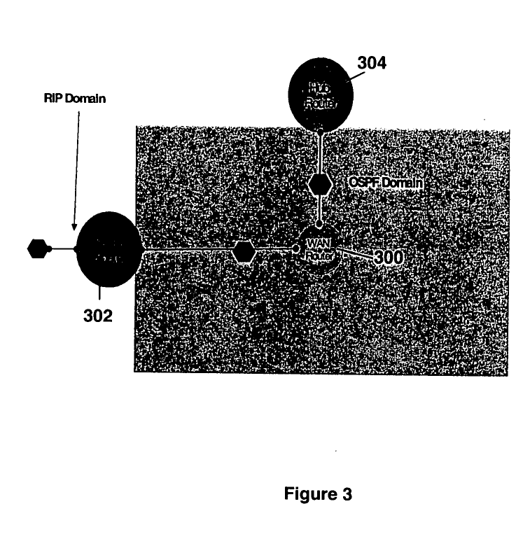

Now request Alloy to find a model for PhysicalSpec in the above scope. The result is synthesis of the network shown in FIG. 3 including WAN router 300, spoke router 302, and hub router 304.

It does so by producing the following values of configuration parameters:

```
routing :
  {externalInterface_0 -> ospfDomain_0,
  externalInterface_1 -> ospfDomain_0,
  hubExternalInterface_0 -> ospfDomain_0,
  internalInterface_0 -> ripDomain_0,
  spokeExternalInterface_0 -> ospfDomain_0}
chassis :
  {externalInterface_0 -> wanRouter_0,
  externalInterface_1 -> wanRouter_0,
  hubExternalInterface_0 -> hubRouter_0,
  internalInterface_0 -> spokeRouter_0,
  spokeExternalInterface_0 -> spokeRouter_0}
network :
  {externalInterface_0 -> externalSubnet_1,
  externalInterface_1 -> externalSubnet_0,
  hubExternalInterface_0 -> externalSubnet_0,
  internalInterface_0 -> internalSubnet_0,
  spokeExternalInterface_0 -> externalSubnet_1}
```

Note that Alloy automatically produces instances of object types in the scope, e.g., wanRouter_{—}0, hubRouter_{—}0, spokeRouter_{—}0. Spoke router 302 and hub router 304 are not directly connected, in accordance with Requirement 9, above.
Requirement Strengthening

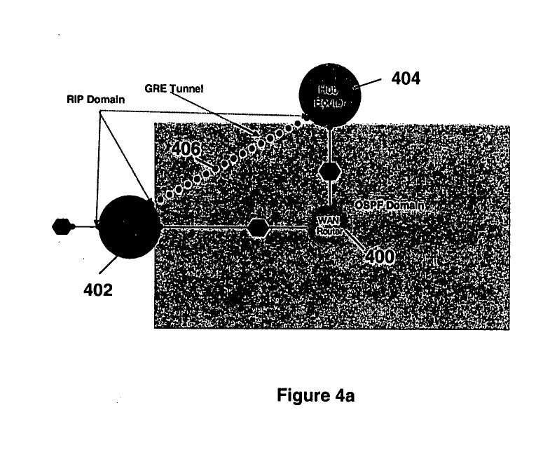

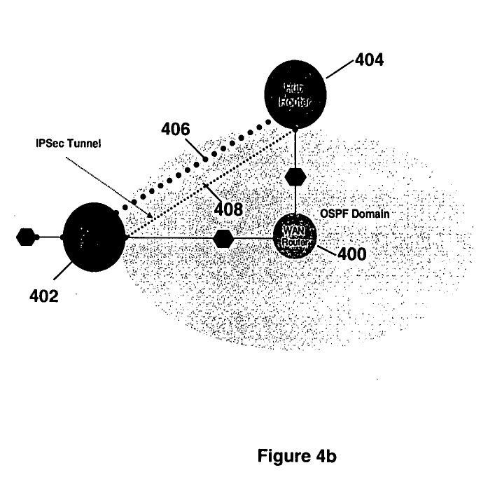

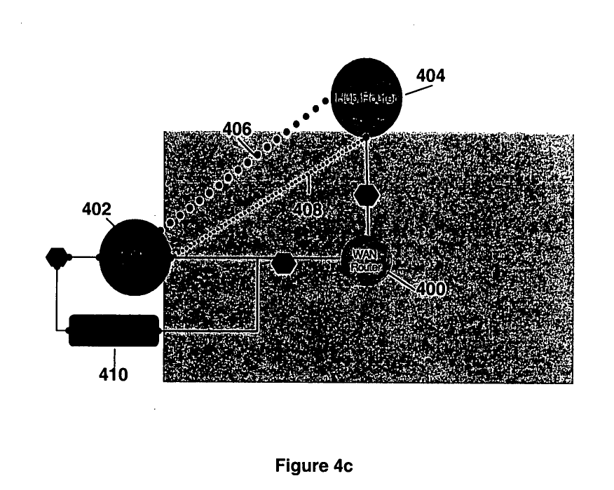

In order to add an overlay network to the previous network, extend the previous scope with a GRE tunnel 400 then request Alloy to satisfy (PhysicalSpec A GRERequirements). Alloy synthesizes the network shown in FIG. 4a.

Alloy automatically sets up the GRE tunnel between the spoke router 402 and hub router 404 and enables RIP routing on the GRE tunnel.

To make GRE tunnels 406 secure, extend the previous scope with an IPSec tunnel 408 and request Alloy to satisfy (PhysicalSpec A GRERequirements A SecureGRERequirements). Alloy synthesizes the network shown in FIG. 4b.

Alloy automatically places the IPSec tunnel between the correct physical interfaces to protect the GRE tunnel.

In order to add an access server 410 to this network extend the previous scope with an access server, one internal interface, and one external interface and request Alloy to satisfy (PhysicalSpec [symbol] GRERequirements [symbol] SecureGRERequirements [symbol] AccessServerRequirements). Alloy synthesizes the network shown in FIG. 4c.

Note that the access server is placed in parallel with only the spoke router, not with any other router, and has the correct routing protocols enabled on its interfaces.

Component Addition

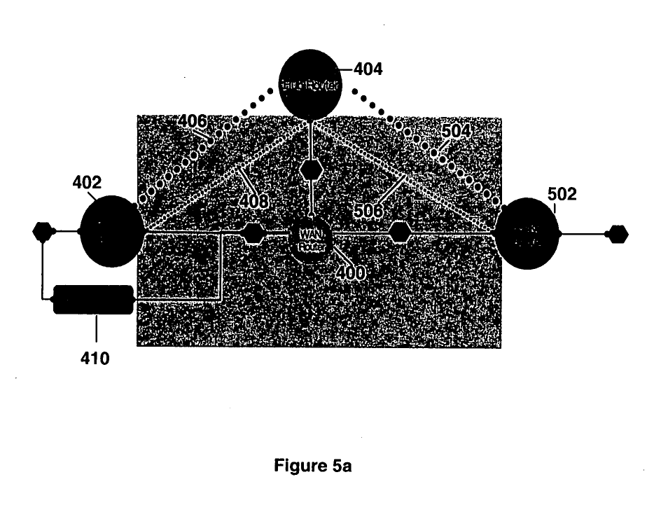

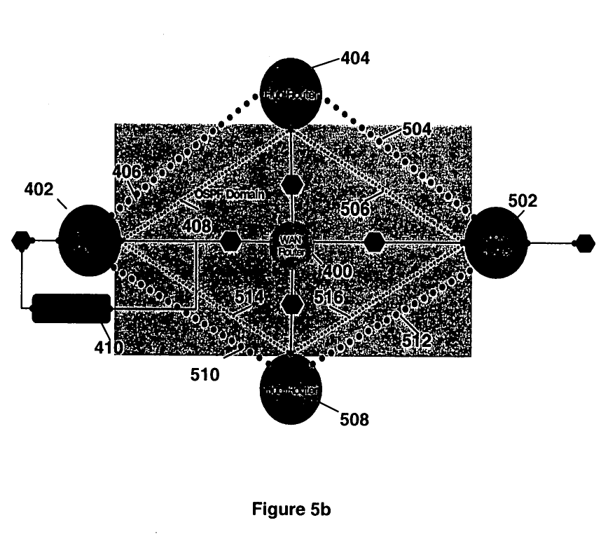

In order to add a new spoke site to the previous network, extend the scope of the network in FIG. 4c with a spoke router 502, one internal subnet, one external subnet, one GRE tunnel 504 and one IPSec tunnel 506. Requesting Alloy to synthesize a network satisfying (PhysicalSpec [symbol] GRERequirements [symbol] SecureGRERequirements [symbol] AccessServerRequirements) in the new scope yields the network shown in FIG. 5a.

The new spoke router 502 is physically connected just to the WAN router 400 as required by Requirement 8. Moreover, GRE tunnel 504 and IPSec tunnel 506 are automatically set up between the new spoke router 502 and hub router 404 and physical interfaces and GRE tunnel 504 are placed in the correct routing domains.

In order to add a new hub site to this network, extend the scope of the network shown in FIG. 5a with a hub router 508, one external interface, one external subnet, two GRE tunnels 510, 512 and two IPSec tunnels 514, 516. Requesting Alloy to synthesize a network satisfying (PhysicalSpec [symbol] GRERequirements [symbol] SecureGRERequirements [symbol] AccessServerRequirements) in the new scope yields the network shown in FIG. 5b.

Finally, in order to permit IKE and ESP (protocols of IPSec) packets through the physical interfaces of hub and spoke routers, one can extend the above scope of the network shown in FIG. 5b with 8 firewall policies, then request Alloy to satisfy:
FullVPNSpec=(PhysicalSpec [symbol] GRERequirements [symbol] SecureGRERequirements [symbol] AccessServerRequirements [symbol] FirewallPolicyRequirements)
Alloy then synthesizes the network of FIG. 2 without the hosts. The reason for 8 firewall policies is that one policy is required for each IPSec tunnel endpoint.
Requirement Verification: Identifying Incorrect Firewall Policies

When the network in FIG. 5b is deployed, one must be careful to allow IKE and ESP packets to be permitted by access control lists at physical interfaces of hub and spoke routers. This was the reason for FirewallPolicyRequirements. However, the end-to-end connectivity was still not established. After considerable testing and analysis it became apparent that the WAN router itself was blocking IKE and ESP packets. The following shows how to formalize identification of this problem. Define a condition called BlockedIPSec capturing conditions under which an IPSec packet can be blocked, and find out how it is possible that (FullVPNSpec [symbol] BlockedIPSec) be true. In other words, is it possible that the network be configured in a manner consistent with FullVPNSpec yet block IPSec packets? If so, it is necessary to modify requirements to preclude this possibility.

The predicate below states that IPSec is blocked if there is some ESP or IKE packet which is blocked.

```
pred BlockedIPSec ( )
{some p:ipPacket, s,t:externalInterface |
    p.source = s &&
    p.destination = t &&
    (p.prot = ike or p.prot=esp) &&
    Blocked(p)}
```

The predicate below states that a packet is blocked if there is some firewall policy protecting an external interface that denies the protocol for that packet:

```
pred Blocked(pack:ipPacket) {
    some p:firewallPolicy, x:externalInterface |
    p.protectedInterface = x &&
    p.prot=pack.prot &&
    p.action = deny
    }
```

If the scope of the network in FIG. 5b is increased to include some number of firewall polices more than 8, for example 9 firewall policies, and request Alloy to find a model for (FullVPNSpec A BlockedIPSec), Alloy produces the following values for prot, permission and protectedInterface attributes of firewall policies:

```
prot : =
  {firewallPolicy_0 -> ike_0,
  firewallPolicy_1 -> ike_0,
  firewallPolicy_2 -> ike_0,
  firewallPolicy_3 -> ike_0,
  firewallPolicy_4 -> esp_0,
  firewallPolicy_5 -> esp_0,
  firewallPolicy_6 -> esp_0,
  firewallPolicy_7 -> esp_0,
  firewallPolicy_8 -> ike_0}
permission: =
  {firewallPolicy_0 -> permit_0,
  firewallPolicy_1 -> permit_0,
  firewallPolicy_2 -> permit_0,
  firewallPolicy_3 -> permit_0,
  firewallPolicy_4 -> permit_0,
  firewallPolicy_5 -> permit_0,
  firewallPolicy_6 -> permit_0,
  firewallPolicy_7 -> permit_0,
  firewallPolicy_8 -> deny_0}
protectedInterface : =
  {firewallPolicy_0 -> spokeExternalInterface_1,
  firewallPolicy_1 -> spokeExternalInterface_0,
  firewallPolicy_2 -> hubExternalInterface_1,
  firewallPolicy_3 -> hubExternalInterface_0,
  firewallPolicy_4 -> spokeExternalInterface_1,
  firewallPolicy_5 -> spokeExternalInterface_0,
  firewallPolicy_6 -> hubExternalInterface_1,
  firewallPolicy_7 -> hubExternalInterface_0,
  firewallPolicy_8 -> externalInterface_0}
```

In other words, firewallPolicy_{—}8, applied on externalInterface_{—}0 on the WAN router, blocks ike_{—}0.
Identifying Advertisement of Private Subnets into WAN

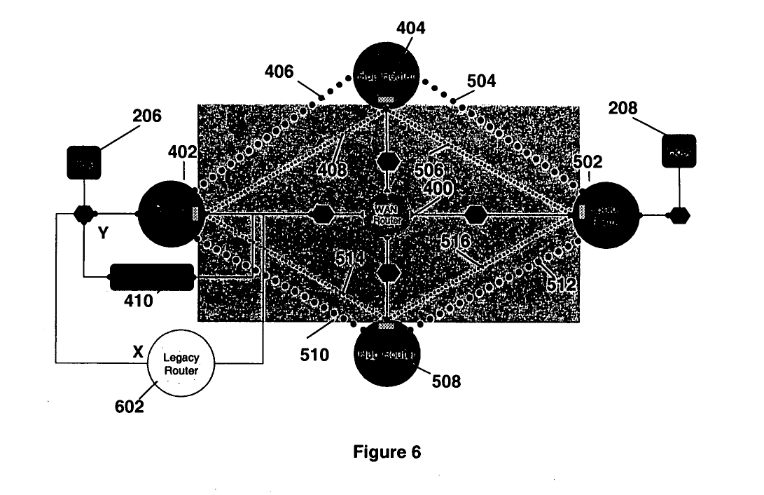

Another problem that arose during deployment of the VPN solution into an existing network occurs because existing networks contain “legacy” routers that have no concept of internal or external subnets as do spoke routers. Thus, if the VPN is grafted into an existing network as shown in FIG. 6, the defense-in-depth feature mentioned above in connection with the network shown in FIG. 2 is compromised. The legacy router can run the same routing protocol on both its internal and external interfaces and thereby export the internal subnet Y to the WAN. Now, if the WAN router is compromised, an adversary can send packets to the host at Y. The following shows how to formalize identification of this possibility. Define:

```
pred internalSubnetAdvertisedToWan ( )
    {some r:legacyRouter, x:physicalInterface, y:physicalInterface,
        s:internalSubnet, e:externalSubnet |
        x.chassis=r &&
        y.chassis=r &&
        x.network=s &&
        y.network=e &&
        x.routing=y.routing}
```

This predicate states that an internal subnet is advertised to the WAN if there is a legacy router with two interfaces, one attached to an internal subnet and another to an external subnet, and both have the same routing protocol enabled on them. Now, if we increase the scope of the network of FIG. 5b to include one additional (legacy) router 602 and two additional physical interfaces, and request Alloy to find a model for (FullVPNSpec [symbol] internalSubnetAdvertisedToWan), Alloy produces the following:

```
routing : =
  {physicalInterface_0 -> ospfDomain_0,
  physicalInterface_1 -> ospfDomain_0,
  ......}
chassis : =
  {physicalInterface_0 -> legacyRouter_0,
  physicalInterface_1 -> legacyRouter_0,
  ......}
network : =
  {
  physicalInterface_0 -> externalSubnet_3,
  physicalInterface_1 -> internalSubnet_1,
  ......}
```

In other words, PhysicalInterface_{—}0 and physicalInterface_{—}1 can be placed on legacyRouter_{—}0, one can be connected to an internal subnet, the other to an external subnet, and yet both can belong to ospfDomain_{—}0.
Writing Efficient Requirements
Scope Splitting

One critical parameter to control in Alloy is the size of the scope. If it gets too large it should be split up and the specification changed, if necessary. Consider the following specification declaring router and interface types, and a relation chassis mapping an interface to its router. Also define EmptyCond to be an empty set of constraints to satisfy (Alloy requires some constraint before it can be run).

sig router { }
sig interface {chassis: router}
pred EmptyCond ( ) { }

When Alloy tries to find a model for EmptyCond in a scope consisting of 50 routers and 50 interfaces it crashes. This is because the cross product of the set of all routers and chassis' has 50*50=2500 pairs. Each subset of this product is a value of the chassis relation. Since there are 2ˆ2500 subsets, there are that many possible values to enumerate.
Now, try splitting the scope and redefining the specification:
sig hubRouter { }
sig spokeRouter { }
sig hubRouterInterface {chassis:hubRouter}
sig spokeRouterInterface {chassis:spokeRouter}
   Alloy returns a model of EmptyCond for the scope consisting of 25 hubRouters, 25 spokeRouters, 25 hubRouterInterfaces and 25 spokeRouterInterfaces in seconds. Note that the scope still contains 50 routers and 50 interfaces. But there are now “only” 2 ˆ625*2ˆ625=2ˆ1250 possible values of chassis relation, or a factor of 2ˆ1250 less.
   The scope splitting heuristic has been followed to structure the space of different routers and interfaces in the fault-tolerant VPN.
   Minimizing Number of Quantifiers in Formulas

Requirements containing quantifiers are transformed into Boolean form by instantiating quantified variables in all possible ways. The number of instantiations is the product of the number of instantiations of each quantified variable. The number of instantiations of each quantified variable is the size of the scope of that variable. In order to prevent the Boolean form from becoming excessively large, one can keep the number of quantified variables in a requirement as small as possible. For example, consider the definition of FirewallPolicyRequirements in which only two explicit quantifiers appear per requirement:

```
pred FirewallPolicyRequirements ( )
{
(all t:ipsecTunnel | some p1:firewallPolicy |
    p1.protectedInterface = t.local &&
    p1.prot = ike &&
    p1.action = permit) &&
(all t:ipsecTunnel | some p1:firewallPolicy |
    p1.protectedInterface =t.remote &&
    p1.prot = ike &&
    p1.action = permit) &&
(all t:ipsecTunnel | some p1:firewallPolicy |
    p1.protectedInterface = t.local &&
    p1.prot = esp &&
    p1.action = permit) &&
(all t:ipsecTunnel | some p1:firewallPolicy |
    p1.protectedInterface = t.remote &&
    p1.prot = esp &&
    p1.action = permit)
(no disj p1,p2:firewallPolicy | p1.protectedInterface=p2.protectedInterface
    && p1.prot=p2.prot && !p1.action=p2.action)
}
```

A more compact definition in which five quantifiers appear in a single requirement is:

```
pred FirewallPolicyRequirements ( )
{
(all t:ipsecTunnel | some p1,p2,p3,p4:firewallPolicy |
    p1.protectedInterface = t.local &&
    p1.prot = ike &&
    p1.action = permit &&
    p2.protectedInterface = t.remote &&
    p2.prot = ike &&
    p2.action = permit &&
    p3.protectedInterface = t.local &&
    p3.prot = esp &&
    p3.action = permit &&
    p4.protectedInterface = t.remote &&
    p4.prot = esp &&
    p4.action = permit)&&
(no disj p1,p2:firewallPolicy | p1.protectedInterface=p2.protectedInterface
    && p1.prot=p2.prot && !p1.action=p2.action)
}
```

In both cases, the number of IPSec tunnels in the scope is 4 and the number of firewall policies 9. However, there is a large difference in the size of the Boolean formula produced (for the entire VPN specification). In the first case, the formula contains 216,026 clauses and 73,4262 literals, and the entire process (compilation to solution) took 2 minutes and 59 seconds. In the second case, the formula contains 601,721 clauses and 2,035,140 literals and the entire process took 8 minutes and 19 seconds.
Avoiding Unintended Answers

Consider the requirement:

Between every hub and spoke router there is a GRE tunnel

This does not exclude GRE tunnels between hub and WAN routers, or between spoke and WAN routers or between WAN and WAN routers. It is possible to strengthen the above requirement to preclude these possibilities, e.g.:

There is no GRE tunnel between a hub and WAN router

There is no GRE tunnel between a spoke and WAN router

There is no GRE tunnel between WAN routers

. . .

This can be quite unwieldy. An alternative is to specify just the first requirement but supply, in the scope, only the number of tunnels intended by the requirement. Alloy will consume these to satisfy the requirement. Thereafter, it will not have any more tunnels left to produce unintended possibilities. One will now have to carefully calculate the scope but at least requirements become much less in number. Not only is the size of associated Boolean formulas reduced, but also requirements become easier to visualize.

While the network configuration management by model finding method has been described in the context of a virtual private network, the method is equally applicable to other protocols, including but not limited to, VoIP and mobile hosted networks.

Portions of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

While there has been described and illustrated a method of network configuration management by model finding, it will be apparent to those skilled in the art that variations and modifications are possible without deviating from the broad teachings and scope of the invention which shall be limited solely by the scope of the claims appended hereto.

What is claimed is:

1. A method of network configuration management by model finding comprising the steps of:
providing a Requirement Solver;
providing as a first input to the Requirement Solver a set of network components;
providing as a second input to the Requirement Solver requirements of component configurations; and
obtaining as an output of the Requirement Solver a component configuration satisfying the requirements.

2. A method as set forth in claim 1, where the Requirement Solver is implemented in Alloy.

3. A method as set forth in claim 2, where the Requirement Solver allows for the definition of first-order constraints on objects and their attributes and a scope of the number and types of objects in the Requirement Solver.

4. A method as set forth in claim 1, where the Requirement Solver allows for the definition of first-order constraints on objects and their attributes and a scope of the number and types of objects in the Requirement Solver.

5. A method as set forth in claim 1, where a set of network components of different types is modeled as a scope.

6. A method as set forth in claim 1, where the requirements of component configurations includes an additional requirement.

7. A method as set forth in claim 2, where the requirements of component configurations includes an additional requirement.

8. A method as set forth in claim 1, where the set of network components includes an additional component.

9. A method as set forth in claim 2, where the set of network components includes an additional component.

10. A method as set forth in claim 1, where the requirements of component configurations also include an undesirable requirement.

11. A method as set forth in claim 2, where the requirements of component configurations also include an undesirable requirement.

12. A method as set forth in claim 1, where the configuration is a set C of constraints of the form P=V, where P is a parameter and V is its value, and requirements are the requirement R and the set of constraints C.

13. A method as set forth in claim 1, where the configuration is a set C of constraints of the form P=V, where P is a parameter and V is its value, and requirements are the requirement R and the set of constraints C.

14. A method as set forth in claim 1, further comprising obtaining as another output of the Requirement Resolver a component configuration as close as possible to the current configuration.

15. A method as set forth in claim 2, further comprising obtaining as another output of the Requirement Resolver a component configuration as close as possible to the current configuration.

16. A method of synthesizing a fault-tolerant network that enables hosts, including mobile hosts, at geographically distributed sites to securely collaborate, comprising the steps of:
set parameters;
define PhysicalSpec;
define a scope; and
find a model for PhysicalSpec in the scope.

17. A method as set forth in claim 16, where the PhysicalSpec comprises RouterInterfaceRequirements, and SubnettingRequirements, and RoutingRequirements.

18. A method as set forth in claim 17, where the RouterInterfaceRequirements comprises each spoke router has internal and external interfaces, each access server has internal and external interfaces, each hub router has only external interfaces, and each WAN router has only external interfaces.

19. A method as set forth in claim 17, where SubnettingRequirements comprises a router does not have more than one interface on a subnet, all internal interfaces are on internal subnets, all external interfaces are on external subnets, every hub and spoke router is connected to a WAN router, and no two non-WAN routers share a subnet.

20. A method as set forth in claim 17, where RoutingRequirements comprises RIP is enabled on all internal interfaces and OSPF is enabled on all external interfaces.

21. A method as set forth in claim 16, where the scope comprises 1 hubRouter, 1 spokeRouter, 1 wanRouter, 1 internalInterface, 4 externalInterface, 1 hubExternalInterface, 1 spokeExternalInterface, 1 ripDomain, 1 ospfdomain, and 3 subnets.

22. A method as set forth in claim 17, where the scope further comprises GRE tunnel and the PhysicalSpec further comprises GRERequirements.

23. A method as set forth in claim 22, where the GRERequirements comprises there is a GRE tunnel between each hub and spoke router and RIP is enabled on all GRE interfaces.

24. A method as set forth in claim 22, where the scope further comprises a spoke router, one internal subnet, one external subnet, one GRE tunnel and one IPSec tunnel and the PhysicalSpec further comprises SecureGRERequirements and AccessServerRequirements.

25. A method as set forth in claim 24, where the SecureGRERequirements comprises for every GRE tunnel there is an IPSec tunnel between associated physical interfaces that secures all GRE traffic, and the AccessServerRequirements comprises there exists an access server and spoke router such that the server is attached in “parallel” to the router.

26. A method as set forth in claim 25, further comprising defining a condition BlockIPSec capturing conditions under which an IPSec packet can be blocked and find where FullVPNSecΛBlockedIPSec is true.
